(19) United States
(12) Patent Application Publication
(10) Pub. No.: US 2015/0345681 A1
(43) Pub. Date: Dec. 3, 2015

(54) UNIVERSAL TAP ADAPTER

(71) Applicant: INIZIATIVA CENTRO SUD S.R.L., Napoli (NA) (IT)

(72) Inventor: Diego SODO, Napoli (IT)

(73) Assignee: INIZIATIVA CENTRO SUD S.R.L., NAPOLI (IT)

(21) Appl. No.: 14/655,101

(22) PCT Filed: Dec. 23, 2013
(86) PCT No.: PCT/EP2013/077964

§ 371 Date: Jun. 24, 2015

(30) Foreign Application Priority Data
Dec. 24, 2012 (IT) RM2012A000663

(51) Int. Cl. F16L 33/24; F16L 33/32; F16L 21/00

(52) U.S. Cl. CPC F16L 33/24; F16L 21/00; F16L 33/32

(57) ABSTRACT

A universal tap adapter has a body (10) provided at the top with retaining elements (18) to clamp a tap (R), a housing (6) for a centrally bored flat gasket (2) to seal against leakage from the nozzle of tap (R), and lower attachment elements (14) to a user device such as an ejector, an irrigator or a shower via a quick coupling and a hose, the housing (6) containing, beneath the centrally bored flat gasket (2), a centrally bored lip gasket (3) that is loaded by a helical spring (5).

### TECHNICAL FIELD

The present invention relates to a universal tap adapter, namely a tap fitting that can be connected to a variety of taps independently of their model or of the shape and cross-section of their nozzle. Such a tap fitting works as a connector between the tap and a user device, such as an ejector, a water jet or a shower, for example by means of a quick coupling and a hose. A connector of this kind is required when the above user device is used away from home, for example, when travelling, and the quick coupling of the user device is not applicable to the currently available tap.

### BACKGROUND ART

There are several documents that describe adapters or connectors, among the others U.S. Pat. Nos. 778,491, 1,734,757, 2,219,813, and 4,822,076. They disclose adapters having some common features: all of them comprise a collar-shaped retaining upper part that is designed to be fixed to a tap generally by means of three angularly equidistant screws, and an attachment lower part for coupling the adapter to a user device. The attachment lower part is connected, by means of threaded coupling, to the retaining upper part, and interposed between the upper part and the lower part is an annulus-shaped flat gasket. The upper face of the flat gasket is maintained adherent to the tap nozzle by tightly screwing the attachment lower part to the retaining upper part.

The adapters according to the above mentioned patents have some drawbacks. Structurally, a drawback depends on the fact that they are formed by a considerable number of parts that require precision machining as they are functionally joined between them. Other drawbacks occur in the installation, which on the contrary should be quick and comfortable since the adapter is installed on the tap only when needed and then removed from it. In the mentioned devices instead the retaining upper part is locked on the tap nozzle by operating individually on the three screws, and subsequently the coupling of the attachment lower part must be adjusted to the retaining upper part. All the screws must be tightened evenly so that the tap nozzle is centred on the flat gasket, otherwise there is a risk of an imperfect seal. Functionally, a single centrally perforated flat gasket does not guarantee an effective seal, unless the coupling between the retaining upper part and the attachment lower part is adjusted with precision.

An adapter of the same type of those above mentioned that is disclosed in U.S. Pat. No. 1,292,524 has a gasket in the form of a hollow truncated conical elastic washer. A peripheral ring of the gasket is clamped between the retaining upper part and the attachment lower part, and the walls of the gasket are converging and tapered downwardly to adhere to the tap nozzle. A lower end of the truncated conical elastic washer is free and is materially smaller than the tap nozzle, so that it must be stretched in order to pass over the latter. The adapter according to the above patent uses the pressure of the water which enters the attachment lower part and presses the truncated conical elastic washer against the tap, thereby assisting the elasticity of the material in preserving a leak-tight joint.

Therefore, U.S. Pat. No. 1,292,524 provides an adapter which solves the problem of the hermetic seal; since, however, the truncated conical elastic washer must be chosen in function of the diameter of the tap nozzle, the adapter as proposed is not applicable to each tap nozzle. Moreover, the adapter according to U.S. Pat. No. 1,292,594 as well as the devices according to the aforementioned patents, has screws that must be screwed one by one in the retaining upper part to the tap nozzle with consequent drawbacks as above mentioned.

Cited as relevant in a previous research on a national patent application which relates to the same invention are French patent FR1.128.637 and U.S. Pat. No. 6,572,154.

FR1.128.637 concerns a universal fitting of the type in question consisting of a cylindrical housing. Screwed in an upper edge of the cylindrical housing are screws which serve to fasten the universal fitting to a tap nozzle of any diameter. The housing has a threaded hole in the bottom to which a threaded upper end of a tubular element is screwed. The tubular element has both a collar and a threaded lower part. A flanged nut supporting the collar of a tube of a user device can be screwed in said threaded lower part. An annular gasket of plastics is mounted in the housing, and a metal washer being placed under the annular gasket of plastics abuts the upper end of the tubular element. The metal washer according to the cited patent has not a function of hermetic seal with the body of the adapter.

U.S. Pat. No. 6,572,154 describes a conical fitting without thread to mechanically connect pipes of fluid transmission. The fitting comprises a diametrically sealed piston having a frustum-shaped profile which engages a corresponding end of a tube for fluid transmission. The mechanical connection is obtained by both the action of a compressed spring and the hydrostatic pressure of the fluid flowing through the fitting.

### SUMMARY OF THE INVENTION

Therefore, one object of the invention is to provide a universal tap adapter which allows a hermetic seal to be obtained by using a flat gasket.

Another object of the invention is to provide a universal tap adapter having a retaining upper part and an attachment lower part that do not require an adjustment thereof when the universal tap adapter has to be applied to a tap nozzle.

A further object of the invention is to provide a universal tap adapter made from a small number of parts.

Moreover, an object of the invention is to provide a universal tap adapter that have a very compact construction in a manner that there is no need to combine together various parts because these are already assembled and cooperate with each other without further adjustments.

Yet another object of the invention is to provide a universal tap adapter in which it is not necessary to tighten a lot of clamping screws to a tap nozzle. With reference to the latter object, there is already a device that allows the transmission of the movement of a first screw to other two screws that then are screwed at the same time to the first one. Such a device is described in U.S. Pat. No. 2,985,456 which relates to a collet chuck for lathes in which three screws are operable simultaneously thanks to the fact that their lower end is provided with a toothed head engaging a ring gear that is provided with an internal toothing. The above mentioned device relative to another field of the technique, has an arrangement of cooperating parts which make it complex and not applicable to a tap adapter.

### BRIEF DESCRIPTION OF DRAWINGS

Further characteristics and advantages of the present invention will become most clear from the indicative, and therefore non-limiting, description of embodiments of a universal tap adapter as illustrated in the accompanying drawings in which:

FIG. 1 is an exploded perspective view of a spring seal according to the present invention;

FIG. 2 is a perspective view of a first embodiment of a universal adapter in which the spring seal in FIG. 1 can be inserted, and a wrench thereof;

FIG. 3 is an axial cross-section of the first embodiment of a universal adapter in FIG. 2 complete with a spring seal;

FIG. 4 is an exploded perspective view of the first embodiment of the universal adapter in FIG. 2;

FIG. 5 is a perspective view of a variant of the first embodiment of the universal adapter;

FIG. 6 is a top plan view of the variant of the universal adapter in FIG. 5;

FIGS. 7 and 8 are cross-sections made respectively according to lines A-A and B-B in FIG. 6; and

FIGS. 9 and 10 are exploded perspective views, taken from below and from above, of a second embodiment of a universal adapter according to the present invention.

### DETAILED DESCRIPTION OF THE EMBODIMENT

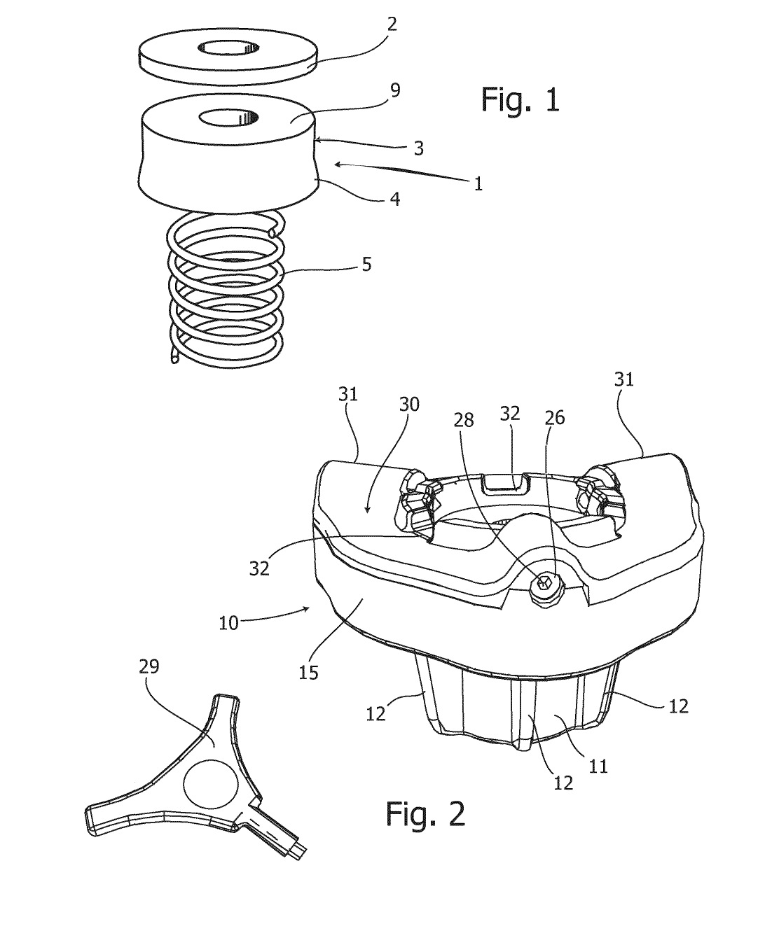

Referring to the figures, shown in FIG. 1 is an exploded perspective view of a spring seal 1 provided for a universal adapter according to the present invention. The spring seal 1 comprises an upper polymeric washer 2 in the form of a flat gasket, for example made of neoprene or silicone, in the shape of an annulus, a lip gasket 3, also in the form of an annulus, provided with a lower peripheral lip-flared protrusion 4, and a helical spring 5. Such a lip gasket is normally used on stems of air cylinders, where it allows a great sliding inside the stem and, at the same time, guarantees an optimum seal with the cylinder walls. It is constructed normally of nitrile rubber, or fluoroelastomers.

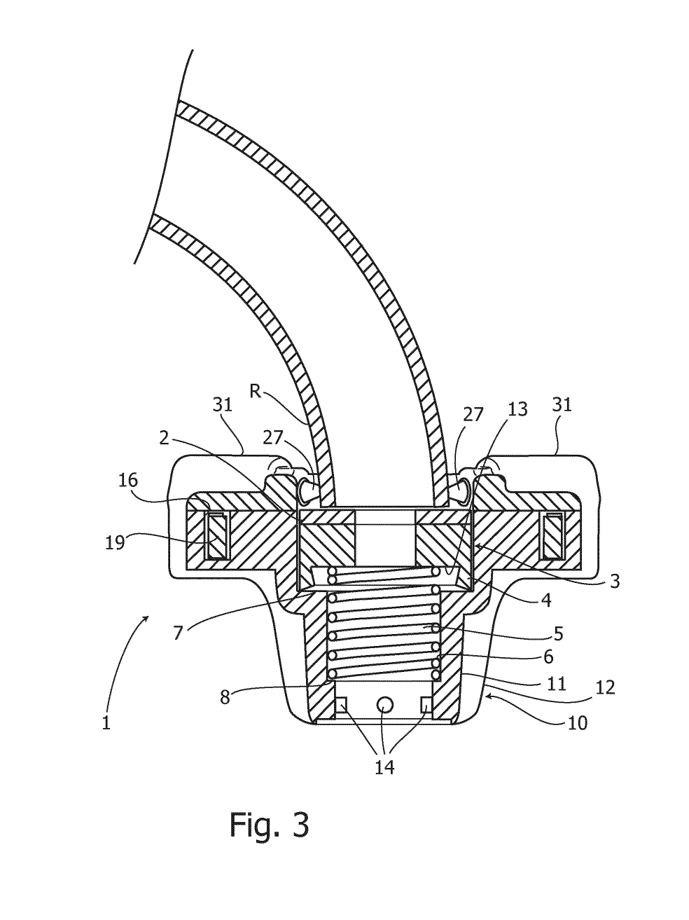

Such a lip gasket is effectively applied in seal with a tap nozzle in a universal adapter or connector, as shown below in various embodiments of the invention. In particular, in FIGS. 2 to 4 there is shown a first embodiment of the adapter, in perspective view, in axial cross-section associated to a portion of the nozzle of a tap R, and in exploded perspective view, respectively. In the arrangement shown in FIG. 3, a housing 6 of the adapter, substantially of cylindrical shape, has a first cross-section narrowing 7 functioning as a stop for the lip gasket 3 and a second cross-section narrowing 8 as abutment of the helical spring 5 that is attested between the second cross-section narrowing 8 of the adapter housing 6 on one side, and the lower surface 13 of the lip gasket 3 on the other. The upper polymeric washer 2, which can also be welded to the upper face 9 (FIG. 1) of the lip gasket 3, is intended to come into contact with the nozzle of the tap R. The upper polymeric washer 2, which has the purpose to avoid leakage from the nozzle of the tap R, is pressed by the antagonistic action of the spring 5 when the adapter is pressed against the nozzle of the tap R. The antagonistic force of the spring 5 is as greater as more the adapter is pressed against the nozzle of the tap R.

The spring 5 then acts both as an element for centering the upper polymeric washer 2 and the lip gasket 3, and as a regulator of the pressure with which they are pressed against the nozzle of the tap R.

As shown in FIG. 1, the lip gasket 3 is located in the rest position and, therefore, its lower peripheral lip-flared protrusion 4 protrudes from the lateral profile of the rest of the gasket. When instead the lip gasket 3 is inserted into the adapter, as shown in FIG. 3, the lip gasket 3 presses, due to its elasticity, against the inner side wall of the adapter housing 6. In the operation of the adapter the pressure that is exerted by the lip gasket against said wall is further increased by the counter-pressure exerted by the water present in the hose of the particular connected user device, e.g. an ejector, an irrigator or a shower. In this way any leakage of water along the inner side wall of the housing 6 outside of the adapter is prevented. Moreover, the counter-pressure of the water cooperates with the spring in pressuring the seal on the tap nozzle.

It is evident that means for retaining the universal adapter to the tap nozzle should be provided. This is achieved thanks to the fact that the housing 6 of the spring seal 1 is provided inside of an adapter body 10 having an upper part intended to be fixed to the nozzle of the tap R through a device with three points of retention.

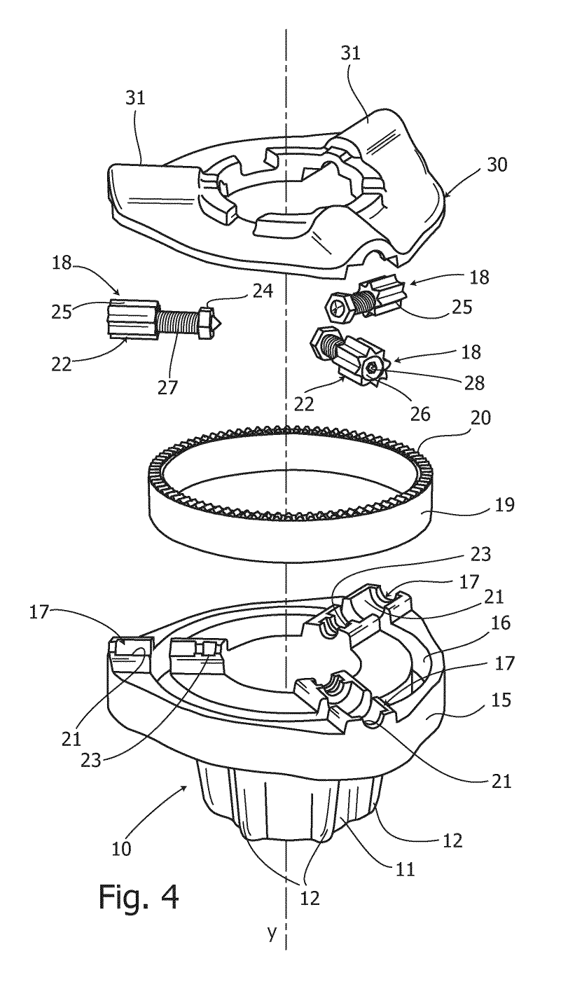

With reference again to the first embodiment, the adapter body 10 comprises a central portion 11 having a vertical axis y, the central portion 11 being provided with meridian ribs 12 adapted to facilitate the grip. The central portion 11, which creates the space for the spring seal 1, terminates at the bottom with rapid attachment means which serve for the attachment of a hose (not shown) of a user device, such as an injector, an irrigator or a shower. The attachment means are represented in FIG. 3 as a series of radially projecting pegs 14, but could also be of different shape. Superiorly, the central portion 11 extends radially in a crown 15. As shown in FIGS. 3 and 4, formed on the upper side of the crown 15 is a circumferential groove 16 that is concentric to the central portion 11 of the adapter. Formed also on the upper side of the crown 15, as shown in FIG. 4, are three radial half seats 17 for screws 18, which are retaining means for retaining the adapter to the nozzle of the tap R.

Received in the circumferential groove 16 with clearance fit is a ring gear 19 having teeth 20 formed on its lateral surface, that is, the upper one in FIG. 4. The three radial half seats 17, astride the circumferential groove 16, have a radially outer channel-shaped portion 21 for the cylindrical head 22 of a screw 18, and a radially inner portion 23 intended to receive a nut 24 steady, i.e. preventing the rotation thereof, for a threaded stem 27 of the screw 18. It is obvious that the number of radial half seats 17, and therefore of the screws 18, can be even greater than three, but it is evident that three screws 18 are sufficient to obtain an optimal clamping. The cylindrical head 22 of each screw 18 is longitudinally grooved to form a straight toothing 25 intended to engage the side teeth 20 of the ring gear 19. Moreover, each cylindrical head 22 of the screws 18 according to the first embodiment of the invention has a face 26 facing the outside, that is, from the opposite side of the stem 27 of the screw 18. Formed in the face 26 of the cylindrical head 22, which can be seen inside the radial half seat 17, is a recessed hexagonal seat 28 (FIG. 2) for a corresponding hexagon wrench 29 with a delta-shaped handle.

Placed above the crown 15 thus formed is a cover 30 having three protruding upward radial half seats 31 for the screws 18, the three radial half seats 31 corresponding to the three radial half seats 17 of the top face of the crown 15, as previously described. The cover 30 is fastened to the crown 15 by means of threaded couplings or by welding the respective materials, e.g. a suitable plastics. The cover 30 serves to lock the nuts 24 in their seats 23, and the heads 22 of the screws 18 are free to move radially when one of them is rotated by the hexagon wrench 29. With the rotation of a single screw 18 being meshed with the teeth 20 of the ring gear 19, the ring gear 19 is rotated and simultaneously transmits the motion to the other screws 18 meshed with it. Due to the arrangement of the screws in their seats formed from the combination of half seats 17 on the crown 15 and of the half seats 31 on the cover 30, the screws 18 are free to move only radially. When the ring gear 19 rotates in one direction, typically clockwise, all the screws 18 advance towards the vertical axis y of the central portion 11, i.e. towards the center of the crown 15 above the spring seal 1. Each screw stem 27 being meshed with its nut 24, moves forward together with the others in order to come into contact with the nozzle of the tap R, so as to retain the adapter thereto. When a screw 18 is rotated counter-clockwise, also the ring gear 19 rotates counter-clockwise and moves away simultaneously all the screws from the tap R, with result of allowing the detachment of the adapter from the tap R. Formed on the cover 30 are three recesses 32 adapted to receive and retain the wrench 29 through its handle when the universal adapter is not installed on the tap.

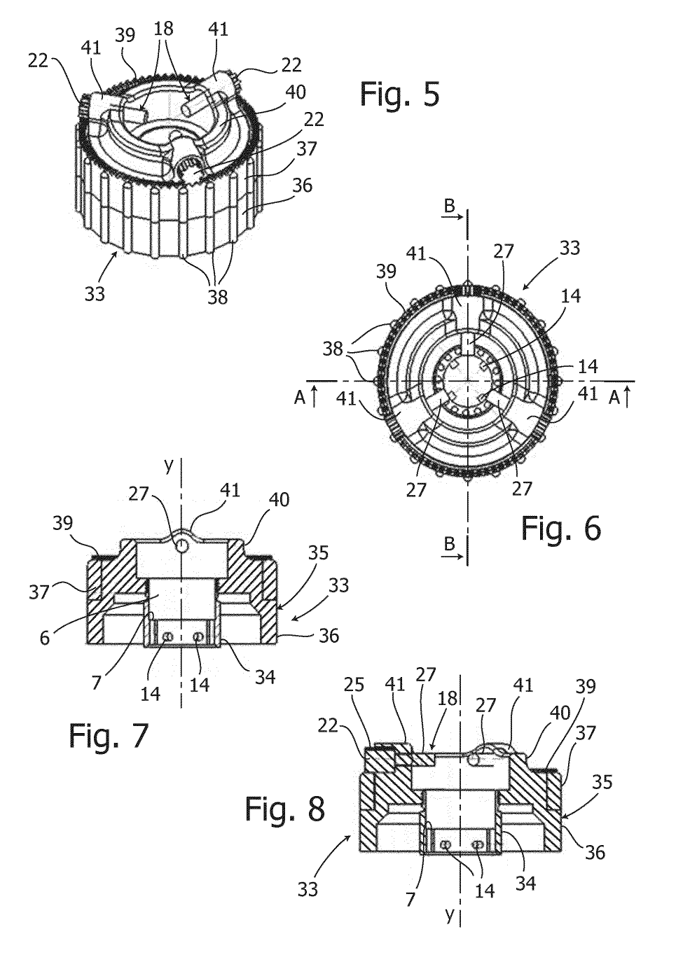

Reference is made now to FIGS. 5 to 8, which are a perspective view and a top plan view of a variant of the first embodiment of the universal adapter and cross-sections along lines A-A and B-B in FIG. 6, respectively. According to this variant, an adapter body 33 comprises a central portion 34 having a vertical axis y that creates the housing 6 for the spring seal 1, which is not represented only for clarity's sake. As in the first embodiment, the central portion 34 is shaped at its bottom with a quick coupling means 14 for the connection with a not shown hose. The central portion 34 extends laterally at the top in a skirt 35 having downwards a side wall 36. Therefore the skirt 35 comprises a top surface (FIG. 5) having in plan the form of an annulus and an outer cylindrical surface. In an upper portion of the skirt 35, its side wall 36 is retracted so as to form a step in which a toothed ring 37 that is freely rotatable around the vertical axis y of the central portion is received. Advantageously, vertical ridges 38 adapted to facilitate manual gripping of the adapter in the rotation of the toothed ring 37 relative to the wall 36 in the skirt 35 are formed on the side wall of both the skirt 35 and the toothed ring 37. The toothed ring 37 has an upper surface provided with projections 39 adapted to form a toothing. The upper surface of the skirt 35 is raised in an annular portion 40 thereof that surrounds the tap nozzle when the adapter is applied thereto. Made angularly equidistant and integrally with the skirt 35, in a radial position with respect to the annular portion 40 are housings 41 for the respective screws 18, as clamping means, which may be similar to those already described with reference to the first embodiment. According to the variant of the first embodiment the screws 18 do not need the hexagonal recessed seat on the outer face of the head 22. The housings 41, three in number as in the first embodiment, are positioned on the upper surface of the skirt 35 so as to contain individually revolving and sliding screws 18 whose toothed head 22 meshes with the toothing 39 that is formed on the toothed ring 37. The stem 27 in each screw 18 engages a thread formed within the housing 41. As the screws 18 are free to move only radially, when the toothed ring 37 rotates in one direction, usually clockwise, all the screws 18 advance towards the vertical axis y above the spring seal 1. Each stem 27 of screw 18, engaging the counter-threaded housing 41, advances together with the others in order to come into contact with the nozzle of the tap R, so as to retain the adapter thereto as in the first embodiment. When the toothed ring 37 rotates counter-clockwise, all the screws 18 move away from the center, allowing the adapter to be detached from the tap R. It should be understood that compared to the first embodiment, the universal adapter according to the variant of the first embodiment in FIGS. 5 to 8 does not require the use of the wrench 29 for installing the adapter to the tap R. By simply operating the toothed ring 37, the screws 18 approach the tap R or distance themselves from it.

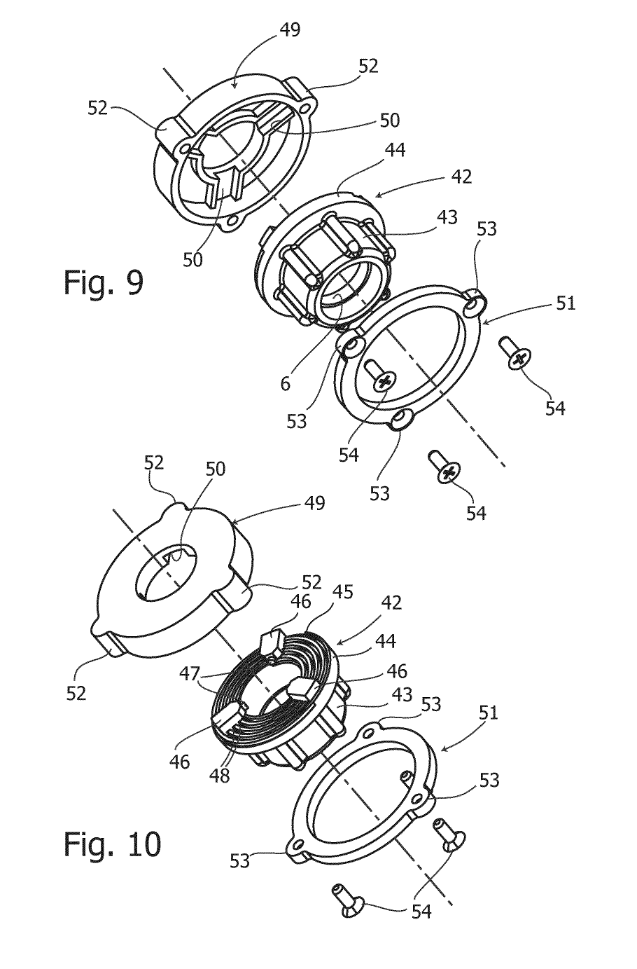

Reference is made now to FIGS. 9 and 10, which are exploded perspective views, from below and from above respectively, of a second embodiment of the universal adapter according to the present invention. In this second embodiment, an adapter body 42 comprises a central portion 43 which internally creates the housing 6 for the spring seal 1. In FIGS. 9 and 10, the spring seal 1 is not shown for simplicity's sake. The central portion 43 of the adapter body 42 has on the top a platform 44 projecting outwards. The platform 44 is centrally bored in correspondence of the housing 6 for the spring seal 1. Made on the upper surface of the platform 44 is a continuous protruding spiral 45 (FIG. 10) that is shaped according to a spiral of Archimedes, whose origin is in the vertical axis y of the central portion 43. Meshed with the continuous protruding spiral 45 are, as clamping means, at least three prismatic inserts generally indicated as 46. Each prismatic insert has a pointed end 47 facing the spiral origin on the vertical axis y of the central portion 43. The prismatic inserts 46 mesh with the continuous protruding spiral 45 by means of curved grooves 48 that are formed on the lower surface of the prismatic inserts 46. The curved grooves 48 of the prismatic inserts 46 are in equidistant position with the same pitch of the turns of the continuous protruding spiral 45 in the platform 44 so that the continuous protruding spiral 45 acts as a guide for the movement of the prismatic inserts 46 along the continuous protruding spiral 45. The prismatic inserts 46 are placed angularly equally spaced on the platform 44. The platform 44 is closed at the top with a cover 49 equipped with radial compartments 50 that constrain the respective prismatic inserts 46 to maintain their radial arrangement toward the origin of the continuous protruding spiral 45. In turn, the cover 49 of the platform 44 is retained thereto by a flange 51 that is located below the platform 44. For the purpose, provided on both the cover 49 and the flange 51 are bored radial projections 52 and 53 respectively, for housing and locking screws 54 for connecting the cover 49 with the flange 51. Such a connection allows the integral rotation of the cover 49 and the flange 51 with respect to the platform 44 and the rest of the adapter about the axis of the central portion 43. Of course, other means of connection between the cover 49 and the flange 51, e.g. welding, can also be used.

When the cover 49 is manually rotated counter-clockwise, the prismatic inserts 46 constrained with it in the respective radial compartments 50 radially advance along the continuous protruding spiral 45 towards the axis of the central portion 43 to clamp the tap R. On the contrary, when the cover 49 rotates clockwise, the prismatic inserts 46 simultaneously move away from the nozzle of the tap R, allowing the detachment of the adapter from the tap itself.

It should be understood that the retaining device in the second embodiment of the universal adapter is similar, as for the operation, to that of the variant of the first embodiment as the retaining device in the second embodiment requires no secondary means for the installation of the adapter to the tap nozzle and the removal from it. However, the shape of the retaining means and the way of their radial movement are different.

1. A universal tap adapter comprising an adapter body (10, 33, 42) being provided with upper retaining means (18) to retain the adapter body (10, 33, 42) to a tap (R), a housing (6) for a centrally bored flat gasket (2) in order to prevent water leakage around the nozzle of the tap (R), and lower attachment means (14) to a user device such as an ejector, an irrigator or a shower through a quick coupling and a hose, characterised in that the housing (6) contains, below the flat gasket (2), a lip gasket (3) that is centrally bored and loaded by a helical spring (5).

2. The adapter according to claim 1, characterised in that the housing (6) has an upper cross-section narrowed portion (7) acting as an abutment for the lip gasket (3), and a lower cross-section narrowed portion (8) for abuting the helical spring (5) against the lip gasket (3).

3. The adapter according to claim 1, characterised in that the adapter body (10) comprises:
a central part (11) that forms the housing (6) having a vertical axis (y) and extending at the top in a crown (15) having an upper side in which a circumferential groove (16) having a vertical axis coincident with the axis (y) of the central part (11) is formed;
a cover (30) intended to be fixed on the crown (15);
a ring gear (19) with a lateral toothing (20) received in said circumferential groove (16);
at least three screws (18) arranged radially between the crown (15) and the cover (30), each screw (18) having a cylindrical screw head (22) provided with a straight toothing (25) for meshing with said lateral toothing (20) of the ring gear (19), and a threaded screw stem (27) coupled with a nut (24), the cylindrical screw head (22) having an end face (26) in which a recessed hexagonal seat (28) for a wrench (29) is formed;
a radial seat (17-31) for each screw (18) formed by the combination of a half seat (17) on the crown (15) and a half seat (31) on the cover (30), the radial seat (17-31) having a radially external channel portion (21) for the sliding of the cylindrical screw head (22) meshing through its straight toothing (25) with said lateral toothing (20), and a radially inner portion (23) intended to receive steady the nut (24) for the threaded screw stem (27),
in such a way that, by rotating a single screw (18) meshing with the toothing (20) of the ring gear (19), the ring gear (19) is rotated which simultaneously transmits the motion to the other screws (18) meshing with the ring gear (19) and being free to move only radially, so that, when the ring gear (19) rotates in one direction, all the screws (18) advance towards the axis (y) of the central part (11) above the flat gasket (2) in order to come into contact with the tap (R), and when the ring gear (19) rotates in the other direction, all the screws (18) move away from the axis (y) of the central part (11) for detaching the adapter from the tap (R).

4. The adapter according to claim 3, characterised in that formed on the cover (30) are three recesses (32) adapted to receive and retain the wrench (29) having a delta-shaped handle.

5. The adapter according to claim 1, characterised in that the adapter body (33) comprises:
a central part (34) that forms the housing (6) having a vertical axis and extending laterally in a skirt (35) which is elongated downwards with a side wall (36) superiorly indented so as to form a step;
a toothed ring (37) received in said step created in the side wall (36) so as to be freely rotatable about the vertical axis (y) of the central part (34), the toothed ring (37) having an upper surface provided with projections (39) adapted to form a toothing;
at least three screws (18) arranged radially on the skirt (35), each screw (18) having a cylindrical head (22) provided with a straight toothing (25) for meshing with said toothing of the toothed ring (37);
an annular portion (40) formed on the skirt (35) in which radially formed are housings (41) for respective screws (18), so that each housing (41) contains rotatably and slidably a screw (18) whose toothed screw head (22) meshes with the toothing (39) formed on the toothed ring (37) and whose screw stem (27) is in engagement with a thread formed within the housing (41)
in such a way that the screws (18) are free to move only radially, when the toothed ring (37) rotates in one direction, towards the vertical axis (y) of the central part (34) in order to come into contact with the nozzle of the tap (R), so as to retain the adapter to the tap (R), and when the toothed ring (37) rotates in the opposite direction, all the screws (18) move away from the axis (y) of the central part (34), allowing the detachment of the adapter from the tap (R).

6. An adapter according to claim 5, characterised in that formed on the side wall (36) of the skirt (35) and on the side wall of the toothed ring (37) are vertical grip projections (38) to facilitate the rotation of the toothed ring (37) with respect to the wall (36) of the skirt (35).

7. An adapter according to claim 1, characterised in that an adapter body (42) comprises:
a central part (43) that forms the housing (6), having a vertical axis and carrying superiorly a platform (44) projecting outwards and centrally bored in correspondence of the housing (6) and having an upper surface;
a continuous projecting spiral (45) on said upper surface being shaped according to an spiral of Archimedes whose origin is in the axis (y) of the central part (43);
at least three prismatic inserts (46) having a bottom surface and a pointed end (47) facing the origin of said spiral of Archimedes and meshing with the continuous projecting spiral (45) through curved grooves (48) formed on their lower surface equidistant between them by the same pitch of the turns of the continuous projecting spiral (45) of the platform (44) so that the continuous projecting spiral (45) serves as a guide for the displacement of the prismatic inserts (46), the prismatic inserts (46) being placed angularly equidistant on the platform (44);
a cover (49) adapted to cover the platform (44) and provided with radial compartments (50) that constrain the respective prismatic inserts (46) so as to retain their radial arrangement towards the origin of the continuous projecting spiral (45), the cover (49) being retained to the platform (44) by coupling with a flange (51) below the platform (44), said coupling allowing the integral rotation of the cover (49) and the flange (51) with respect to the platform (44) and to the rest of the adapter about the axis (y) of the central portion (43),
in such a way that, when the cover (49) is rotated in one direction, the prismatic inserts (46) constrained by the cover (49) in the respective radial compartments (50) radially advance along the continuous projecting spiral (45) towards the vertical axis (y) of the central part (43) until they block the tap (R), and when the cover (49) is rotated in the other direction, the prismatic inserts (46) simultaneously move away from the tap (R), allowing the detachment of the adapter from the tap itself.

8. The adapter according to claim 7, characterised in that radial bored projections (52) and (53) respectively, are provided on the cover (49) and on the flange (51) for housing and locking screws (54) connecting together the cover (49) and the flange (51).
